(19) United States
(12) Patent Application Publication
(10) Pub. No.: US 2006/0031092 A1
(43) Pub. Date: Feb. 9, 2006

(54) Automated IP tracking system and method

(76) Inventor: John E. Cronin, Milton, VT (US)

Correspondence Address: DOWNS RACHLIN MARTIN PLLC, 199 MAIN STREET, P O BOX 190, BURLINGTON, VT, 05402-0190, US

(21) Appl. No.: 11/249,575

(22) Filed: Oct. 13, 2005

Related U.S. Application Data
(63) Continuation of application No. 09/781,362, filed on Feb. 12, 2001.
(60) Provisional application No. 60/181,459, filed on Feb. 10, 2000.
(60) Provisional application No. 60/181,816, filed on Feb. 11, 2000.
(60) Provisional application No. 60/181,741, filed on Feb. 11, 2000.
(60) Provisional application No. 60/181,825, filed on Feb. 11, 2000.

(51) Int. Cl. G06Q 99/00

(52) U.S. Cl. 705/1

(57) ABSTRACT

A method and system for recording and tracking the progress of a plurality of inventions through an Invention Method including IP Mapping, IP Strategy, IP Generation, IP Documentation, IP Review Board, and IP Patenting or Provisional Filing, utilizing a Database platform comprising a plurality of tables, view screens, and reports that characterize the flow of an invention from one method through to the next, from the time an invention is identified until it is patented, and even beyond issuance, or until some other disposition of the invention is made.

### RELATED APPLICATION DATA

This application is a continuation of U.S. application Ser. No. 09/781,362, filed Feb. 12, 2001, and entitled “Automated IP Tracking System and Method,” which is incorporated herein by reference in its entirety.

This application claims the benefit of priority, through the above-identified U.S. application Ser. No. 09/781,362, of U.S. Provisional Patent Application Ser. No. 60/181,459, filed Feb. 10, 2000 and entitled “Process for Facilitating the Conception of Inventions in a Directed Manner,” U.S. Provisional Patent Application Ser. No. 60/181,816, filed Feb. 11, 2000 and entitled “Web-Based Process for Facilitating the Conception of Inventions in a Directed Manner,” U.S. Provisional Patent Application Ser. No. 60/181,741, filed Feb. 11, 2000 and entitled “Invention Interview Process,” and U.S. Provisional Patent Application Ser. No. 60/181,825, filed Feb. 11, 2000 and entitled “Automated IP Process for Tracking IP Matters,” each of which is incorporated by reference herein in its entirety.

U.S. application Ser. No. 09/781,362, identified above, was filed on the same day as the following related applications, each of which is incorporated by reference herein in its entirety: U.S. patent application Ser. No. 09/781,365, entitled “System and Method for Facilitating the Conception of Inventions in a Directed Manner,” U.S. patent application Ser. No. 09/781,368, entitled “Network Based System and Method For Facilitating the Conception of Inventions in a Directed Manner,” and U.S. patent application Ser. No. 09/781,361, entitled “Invention Interview Process.”

This application is related to U.S. patent application Ser. No. 09/766,456, filed on Jan. 19, 2001 and entitled “Scanning Invention Process,” which is incorporated by reference herein in its entirety.

### FIELD OF THE INVENTION

The invention relates to an integrated software system and method for managing intellectual property (IP). The software system of the invention generally includes one or more of the following functional components: patent mapping, patent strategy, invention creation, documentation, invention review, and application filing components.

### BACKGROUND OF THE INVENTION

A variety of software systems are presently in use for accomplishing specific IP tasks. For instance, many large companies and patent firms use patent mapping, patent strategy and patent documentation services.

The patenting community has long used computerized tracking systems to track the prosecution of patent applications in various patent offices around the world. Such tracking systems compile information relating to the applications (e.g., inventor, assignee, application number, filing dates, priority dates, etc.), calculate deadlines relating to the filing and prosecution of patent applications (e.g., bar dates, foreign filing deadlines, response deadlines, issue dates, publication dates, etc.), and create a variety of output reports for use by IP managers. Several systems also generate form documents for use in communicating with patent offices and/or clients, e.g., filing documents, legal documents, client correspondence, and the like. Examples of such computer-based tracking systems include CPI™ and Patsy™.

The Aureka™ system, marketed by Aurigin Systems, Inc., is asserted to create patent landscapes, which facilitate management of innovation assets. The Aureka™ system is stated to aggregate, analyze, and share innovation asset information. The system is further asserted to provide flexible searching and sorting capabilities for databases, such as a database of U.S. patents.

Presently available systems are all highly specific and are generally incompatible with each other. Consequently, there is a need in the art for a comprehensive IP tracking and management system, which integrates a large variety of IP tools. Moreover, presently available tools focus on the management of IP already generated and do not facilitate management of the IP generation process itself. Consequently, there is a need in the art for a comprehensive tool, which facilitates the management of IP generation, which optionally also facilitates tracking of IP prosecution.

### SUMMARY OF THE INVENTION

The invention relates to an integrated software system for intellectual property management. The system of the invention is programmed to perform the following functions: (a) accept input relating to one or more of the following areas: IP mapping-tracking; IP strategy-tracking; IP generation-tracking; IP documentation-tracking; IP review board-tracking; and IP application-tracking; (b) store the input in one or more data files; and (c) provide output indicative of the stored data.

The system of the invention preferably includes an IP mapping-tracking component programmed to track opportunity areas in which inventions are desired. The IP mapping-tracking component is preferably programmed to: (a) utilize input words and phrases descriptive of a market area or technology areas; (b) search databases, such as patent and literature databases; and (c) provide an output which characterizes inventive and research activity in the area.

The system of the invention preferably comprises an IP strategy-tracking component programmed to track invention strategy. The IP strategy-tracking component preferably (a) uses product and technology output from an IP mapping method as input; and (b) produces output comprising problems and elements for use as input in an IP generation component.

The system of the invention may also include an IP generation-tracking component programmed to track creation of new inventions. The IP generation-tracking component is preferably programmed to provide output suitable for use as input into an IP documentation component. The system may include an IP documentation-tracking component programmed to track invention documentation.

Moreover, the system may include an IP review board-tracking component programmed to track the schedule and results of an invention review board. The IP review board tracking component programmed to accept input assigning a disposition to an invention tracked by the system.

Additionally, the system may include an IP application filing-tracking component programmed to track patent application filing data and optionally tracks patent prosecution data. The IP application filing-tracking component is suitably programmed to: (a) capture output from an IP generation method component; and (b) yield invention disclosure output suitable for use as input in an IP review board component of the invention.

Data accepted by the system may suitably include various combinations of the following: invention identification number; technology area; product area; company name; company site; invention title; inventor; manager of inventor; bar date; comments; technology name; product name; problem; elements/methods; IP scanning session name; IP scanning session date; IOD™ session name; IOD™ session date; pre-existing invention; client tracking number; company disclosure number; disclosure writer; IP manager; additional inventorship information; inventor interview date; idea withdrawal date; first draft completion date; inventor's draft review date; disclosure submission date; invention review date; invention review attorney; disclosure rating; search sent date; search received date; attorney review complete date; final disposition; patent docket number; patent docket creation date; docket attorney; docket delivery date; application filing date; notice of allowance date; patent issued date; date of expiration of patent term; docket closure date; and license value.

### BRIEF DESCRIPTION OF THE DRAWINGS

FIG. 1 shows an embodiment of a user interface screen, including identifier information; company and site information; information about the principle inventor and management personnel; the topical area of the invention; a bar date associated with the invention; IP mapping method outcomes; IP strategy method outcomes; and navigational aids.

FIG. 2 shows an embodiment of a user interface screen, including Information pertaining to invention generation activities associated with the invention; information about previous knowledge or disclosure of the invention; information about the IP documentation method associated with the invention; and further information about the inventors and management associated with the invention.

FIG. 3 shows an embodiment of a user interface screen, including further information related to the ip documentation of the invention; information about invention review method associated with the invention; information about searches associated with the invention; information reflecting the IP patenting or provisional filing status of the invention; and information about the IP valuation associated with the invention.

FIG. 4 shows a reporting screen of the invention, including report titles that are available in the invention tracking system; preview report buttons adjacent to each report title which enable display, on the user's screen, of the respective report; and print report buttons adjacent to each report title which enable the printing of the respective report.

### DETAILED DESCRIPTION OF THE INVENTION

The invention relates to an integrated software system for IP management, focusing especially on management of IP issues that occur prior to the filing of a patent application. In a preferred embodiment, the system of the invention provides integrated IP mapping, IP strategy, IP generation, IP documentation, IP review board, and IP patenting or provisional filing.

System Components

The system of the invention generally includes one or more of the following subcomponents:
IP Mapping-Tracking Component: tracks opportunity areas in which inventions are desired
IP Strategy-Tracking Component: tracks invention strategy
IP Generation-Tracking Component: tracks the creation of new inventions
IP Documentation-Tracking Component: tracks invention documentation
IP Review Board-Tracking Component: tracks the schedule and results of the invention review boards
IP Application-Filing Tracking Component: to track patent filing and prosecution

The integrated system of the invention may include any combination of the foregoing components. Each component is discussed in the ensuing subsections.

IP Mapping-Tracking Component

The system includes an IP mapping function, which is useful for obtaining an accurate picture of the IP landscape in a particular market space. Such information is useful for the identification of opportunity areas for focused inventing and yields product and technology descriptors that feed the IP Strategy method. The IP mapping tracking component is useful for tracking changes in opportunity areas defined by a client's products and/or target technology development areas. The mapping component can utilize input words and phrases descriptive of market areas and/or technology areas to search databases, such as patent and literature databases, to provide an output which characterizes inventive and research activity in the area. Output can include textual and/or graphical information relating to companies involved in the area, claims issuing in the area, individuals publishing and/or patenting in the area, research being conducted in the area, and the like.

IP Strategy-Tracking Component

The IP strategy-tracking component uses the product and technology output from the IP Mapping method and identifies problems and elements for use in the IP generation method. The IP strategy-tracking component tracks the direction of invention and records the core problem solved by a given invention, as well as the basic elements of the invention.

IP Generation-Tracking Component

The invention generation-tracking system is driven by the problems and elements developed in the IP strategy-tracking component. Output from the IP generation-tracking component provides input for the IP documentation component. The IP generation-tracking component tracks the creation of invention method and records the progress of the invention method. IP generation is preferably accomplished according to the IOD™ and/or invention scanning aspects of the invention.

IP Documentation-Tracking Component

The IP documentation-tracking component of the system captures the output from the IP generation method and yields invention disclosure documentation, which preferably feeds into the IP review board aspect of the invention. The IP documentation-tracking component accepts input information relating to the production and review of invention disclosure documents.

IP Review Board Tracking Component

The IP review board component of the invention provides a formal review of the IP documentation, which filters a large number of inventions and assigns each invention a disposition, such as file provisional, file utility, file PCT, accomplish further research, publish, etc. The IP review board tracking component tracks the schedule and results of the invention review board process.

IP Application Filing Tracking Component

The IP application filing tracking component tracks the filing of IP applications, such as provisional or utility patent applications. Input for the IP application filing-tracking component is provided by output from the IP review board component. The IP application filing-tracking component may also track patent prosecution filing dates and deadlines.

Software Components

In general, the system of the invention comprises a database and a software system for inputting data into the database. A preferred database is a relational database software platform comprising a series of linked tables containing data that correspond to the invention tracking system. An exemplary database platform is Microsoft Access®. The system also preferably comprises a forms-based entry system that enables a user to enter input information into the database.

Information Types

Examples of information stored in the system of the invention are discussed in the ensuing sections.

IP Identifying Information

Invention ID number: A unique identifier, numeric in the preferred embodiment, but alternatively alphanumeric or alphabetic, that identifies the invention being tracked.

Area: Data field (preferably alphanumeric) for entry of the technology or product area. Examples include semiconductor manufacturing, point source pollution control, medical devices, pharmaceuticals, etc.

Company Name: Data field (preferably alphanumeric) for entry of the name of the company or client for whom the IP matters are being tracked.

Company Site: Data field (preferably alphanumeric) for entry of location information for the site where the subject IP is being developed, produced, and/or managed.

Invention Title: Data field (preferably alphanumeric) for entry of a descriptive title for the invention.

Inventor: Data field (preferably alphanumeric) for entry of name of inventor. The system preferably includes multiple inventor fields.

Manager of Inventor: Data field (preferably alphanumeric) for entry of management or departmental information. Preferably each inventor field is associated with a corresponding manager field.

Bar Date: Field for entry of the earliest date by which a patent application must be filed to avoid losing the right to protect the given invention.

Comments: Alphanumeric field for entry of information that does not fit into another specified field. This may include, for example, secondary inventors.

IP Mapping-Tracking Information

Technology Name: Data field (preferably alphanumeric) for entry of the name of the technology that is the subject of the IP being managed. An example might be “Erasable Ink Chemistry”.

Product Name: Data field (preferably alphanumeric) for entry of data identifying the product that is the subject of the IP being managed.

IP Strategy Tracking information

Problem: Data field (preferably alphanumeric) for entry of the output of the IP strategy-tracking component. The field is used to identify a specific problem addressed by the invention.

Elements/Methods: Data field (preferably alphanumeric) for entry of output of the IP strategy-tracking component. The field is used to identify a specific element utilized to solve the problem.

IP Generation Tracking Information.

IP Scanning Session Name: Data field (preferably alphanumeric) for entry of a name associated with an IP scanning session.

IP Scanning Session Date: Date field for entry of the date of the IP scanning session.

IOD™ Session Name: Data field (preferably alphanumeric) for entry of the name of an IOD™ session associated with the invention.

IOD™ Session Date: Date field for entry of the date of the aforementioned IOD™ session.

Pre-existing Invention: A checkbox field, which indicates whether or not the invention is related to other preexisting internal inventive subject matter.

IP Documentation Tracking information

Client Tracking Number: Data field (preferably alphanumeric) for entry of a client tracking number.

Company Disclosure Number: Data field (preferably alphanumeric) for entry of a client's internal file-reference number for a specific invention disclosure.

Disclosure Writer: Data field (preferably alphanumeric) for entry of the name of the author of the invention disclosure document.

IP Manager: Data field (preferably alphanumeric) for entry of the name of the intellectual property manager.

Additional Inventorship Information: Data field (preferably alphanumeric) for entry of general information about inventors of the invention.

Idea Date Information

Inventor Interview Date: Date field for entry of the date of the invention interview.

Idea Withdrawal Date: Date field for entry of the date when an idea is withdrawn from further consideration for filing.

First Draft Completion Date: Date field for entry of the date when the first draft of an invention disclosure is completed for the invention.

Inventor's Draft Review Date: Date field for entry of the date when an inventor receives the first draft of the invention disclosure. Multiple fields may be provided, i.e., one for each inventor. This may include a predetermined number, e.g., 10 fields, one for each inventor, or may involve a separate field or other means for indicating the number of the inventors, which is used by the system as input for generating an number of date fields exactly corresponding to the number of inventors.

Disclosure Submission Date: Date field for entry of the date when and invention disclosure is submitted to the invention review board.

Invention Review Board-Tracking Information

Invention Review Date: Date field for entry of the date when the invention disclosure output of the invention generation method is examined by the invention review board.

Invention Review Attorney: This alphanumeric field identifies the attorney who reviews the invention.

Disclosure Rating: Data field (preferably alphanumeric) for entry of a rating of the invention under review. Preferred values allowed in this field include:

File. The review board method recommends the invention should be submitted for filing.

Search. The review board method recommends a patent search be undertaken.

Publish. The review board method recommends the invention be published.

Publish-Anon. The review board method recommends the invention be published anonymously.

Close. The review board method recommends the invention disclosure be filed internally, or closed, and no further action pursued.

Need More Information. The review board method recommends that additional information be obtained before proceeding to the next step.

Search Sent Date: Date field for entry of the date that a formal patent search request is sent.

Search Received Date: Date field for entry of the date that a formal Patent Search response is received.

Attorney Review Complete Date: Date field for entry of the date that the invention review board attorney completes the review of an invention.

Final Disposition: Data field (preferably alphanumeric) for entry of final outcome of the invention review board review.

Patent and Provisional Filing-Tracking Information.

Patent Docket Number: Data field (preferably alphanumeric) for entry of the docket number assigned by the USPTO to the filing of the patent application for the invention.

Patent Docket Creation Date: Date field for entry of the date on which the patent docket number is assigned.

Docket Attorney: Data field (preferably alphanumeric) for entry of identifying information about the docket attorney.

Docket Delivery Date: Data field (preferably alphanumeric) for entry of date the patent application is mailed or otherwise delivered to the USPTO.

USPTO Filing Date: Date field for entry of the filing date assigned to the patent application by the USPTO.

Notice of Allowance Date: Date field for entry of the date on which the USPTO issues a Notice of Allowance for the application.

Patent Issued Date: Date field for entry of the date on which the USPTO issues a patent for the invention.

Date of Expiration of Patent Term: Date field for entry of the date on which the USPTO issues a patent for the invention.

Docket Closure Date: Date field for entry of the date on which the docket was closed on the invention, e.g., date of abandonment.

IP Valuation Tracking information

License Value. This numeric field records the estimated License Value of the invention, at any time during the method.

Other Fields

In addition to the foregoing fields, it will be appreciated that the system can be programmed to permit entry of information relating to foreign prosecution, international patent applications, and the like. Examples of other fields usefully included in the system include: examiner name; art unit; priority date; information about parent applications, such as date filed, title, inventors, status, etc.; information about applications claiming priority to present application; status as a continuation application, continuation-in-part application, divisional application, continued prosecution application, continued examination application, and the like; name of foreign agent; dates relating to foreign prosecution; and review board information relating to foreign filing.

Database Navigation

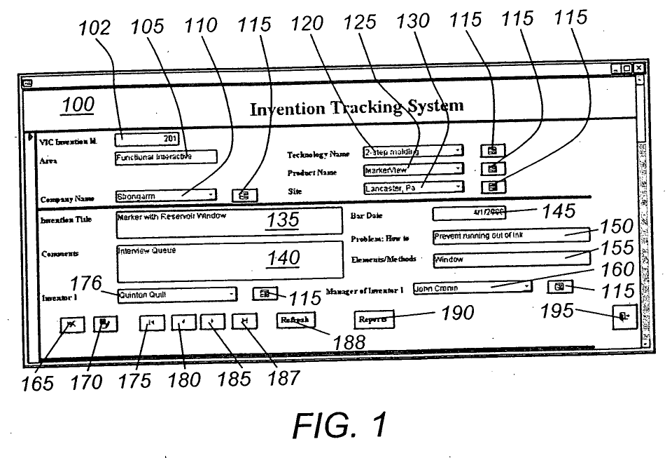

The system is programmed to permit a user to save, delete and navigate among the records of the system. In one embodiment, these functions are accomplished using various on-screen icons, virtual buttons and the like. Examples from FIG. 1 include: delete the current record 165; save the current record 170; display the first record in the database 175; display the last record in the database 187; display the previous record in the database 180; display the next record in the database 185; and refresh the current view 188.

The system of the invention preferably includes means for opening and closing screens and forms associated with the system. Examples from FIG. 1 include: open the reports screen 190; and exit the main screen 195. Open subordinate table screens 115 permits opening of database tables, such as: company; technology name; product name; company site; inventor; inventors' manager; disclosure writer; and IP manager.

System Output

The system includes a reporting sub-system permitting a variety of reports to be generated regarding the status of invention being tracked by the system. Examples of reports are as follows:

Awaiting Interview. A list of inventions being tracked by the system that have reached the IP documentation step but have not been subjected to an invention disclosure interview.

Awaiting First Draft. A list of inventions being tracked by the system that have reached the invention interview method phase, but which do not yet have a complete invention disclosure draft.

Awaiting Invention Review. A list of inventions being tracked by the system that for which invention disclosures have been submitted to respective inventors for review.

Awaiting Disclosure Submit A list of inventions being tracked by the system that that have been reviewed by respective inventors and await entry into the invention review board method.

Awaiting Review Board. A list of inventions being tracked by the system that that have been submitted to the invention review board where the review is not yet complete.

Awaiting Patent Docket. A list of inventions being tracked by the system that have been approved by the invention review board method for filing, but have not been assigned docket numbers.

The invention preferably includes a user interface display screen for use in generating the aforementioned reports. For example, in one embodiment, a desired report can be viewed or printed by clicking a “view” button or a “print” button, respectively, adjacent to the title of the desired report.

The system also preferably includes a viewing and printing subsystem, wherein the previously described reports can be generated on a display or terminal, or printed on a printer.

User Interface Screens

FIGS. 1-4 show user interface screens of one embodiment of the invention.

FIG. 1 shows an invention tracking system record screen 100, which includes: invention ID number 102; area 105; company name 110; table zoom buttons 115; technology name 120; product name 125; company site 130; invention title 135; comments 140; bar date 145; problem: how to 150; elements/methods 155; manager of inventor 1 name 160; inventor 1 name 176; record management buttons 165, 170; navigational buttons 175, 180, 185, 187; refresh button 188; report screen button 190; window exit button 195.

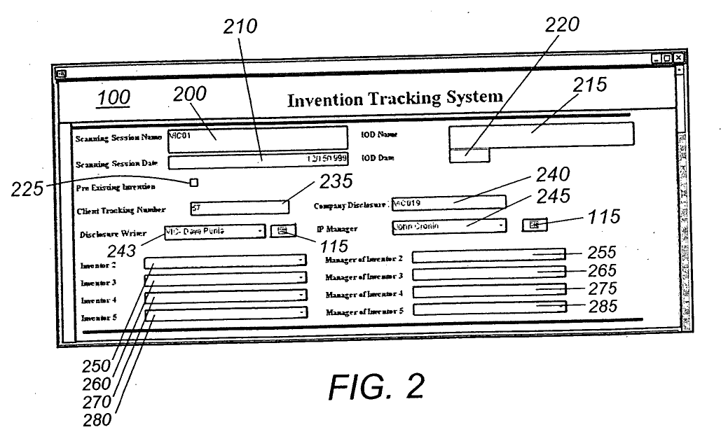

FIG. 2 shows an invention tracking system main screen 100, which includes: IP scanning session name 200; IP scanning session date 210; IOD™ session name 215; IOD™ session date 220; pre-existing invention 225; client tracking number 235; company disclosure number 240; disclosure writer 243; ip manager 245; inventor 2 name 250; inventor 2 manager name 255; inventor 3 name 260; inventor 3 manager name 265; inventor 4 name 270; inventor 4 manager name 275; inventor 5 name 280; inventor 5 manager name 285.

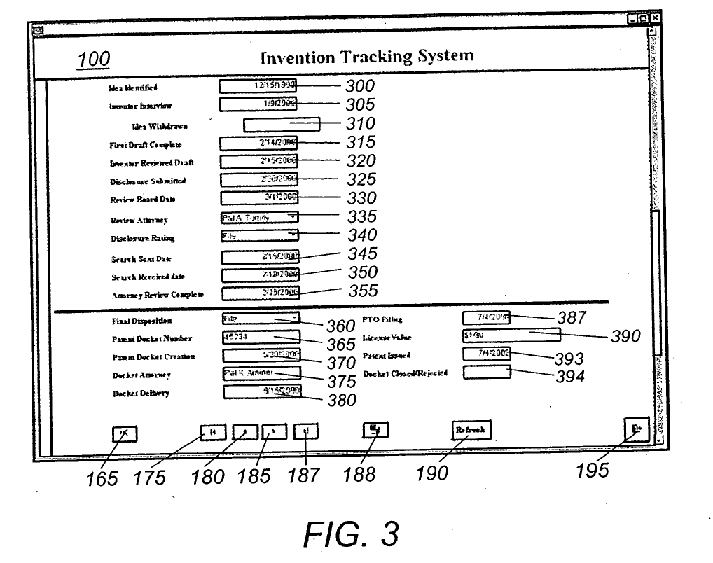

FIG. 3 shows an invention tracking system main screen 100, which includes: idea identified date 300; inventor interview date 305; idea withdrawal date 310; first draft completion date 315; inventor's draft review date 320; disclosure submission date 325; review board date 330; invention review attorney 335; disclosure rating 340; search sent date 345; search received date 350; attorney review complete date 355; final disposition 360; patent docket number 365; patent docket creation date 370; docket attorney 375; docket delivery date 380; PTO filing date 387; patent issued date 393; docket closure date 394; license value 390.

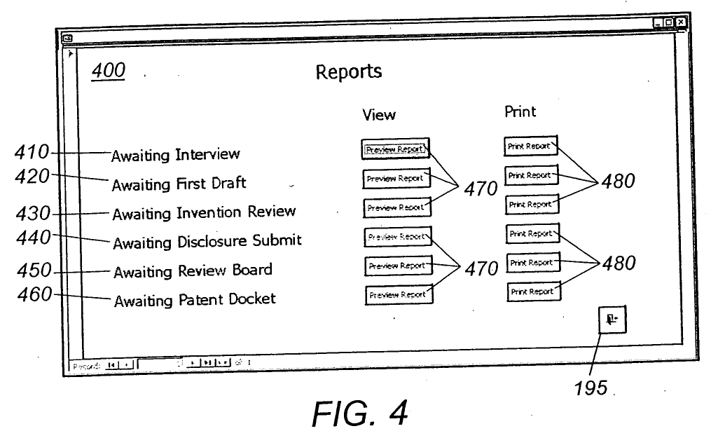

FIG. 4 shows an invention tracking system reports screen 400, which includes: awaiting interview report label 410, and associated preview report 470 and print report 480 buttons; awaiting first draft label 420, and associated preview report 470 and print report 480 buttons; awaiting invention review label 430, and associated preview report 470 and print report 480 buttons; awaiting disclosure submit label 440, and associated preview report 470 and print report 480 buttons; awaiting review board label 450, and associated preview report 470 and print report 480 buttons; awaiting patent docket label 460, and associated preview report 470 and print report 480 buttons.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of processing and presenting data corresponding to unpatented inventions, comprising the steps of:
a) maintaining at least one database containing a plurality of unpatented invention titles corresponding respectively to a plurality of inventions and further containing a plurality of market area names in a manner that relates ones of said plurality of unpatented invention titles to corresponding respective ones of said plurality of market area names; and
b) presenting to a user at least one screen that displays at least one of said plurality of unpatented invention titles and at least one of said plurality of market area names corresponding to said at least one of said plurality of unpatented invention titles.

2. A method according to claim 1, wherein:
step a) further includes maintaining in said at least one database a plurality of problem-solved statements, each directed to a problem solved by a corresponding respective one of said plurality of inventions, in a manner that relates ones of said plurality of problem-solved statements to corresponding respective ones of said plurality of unpatented invention titles; and
step b) further includes presenting on said at least one screen at least one of said plurality of problem-solved statements corresponding to said at least one of said plurality of unpatented invention titles.

3. A method according to claim 1, wherein:
step a) further includes maintaining in said at least one database a plurality of invention elements, each being an element of a corresponding respective one of said plurality of inventions, in a manner that relates ones of said plurality of invention elements to corresponding respective ones of said plurality of unpatented invention titles; and
step b) further includes presenting on said at least one screen at least one of said plurality of invention elements corresponding to said at least one of said plurality of unpatented invention titles.

4. A method according to claim 1, wherein:
step a) further includes maintaining in said at least one database a plurality of technology names, each being a technology into which at least one of said plurality of inventions is categorized, in a manner that relates ones of said plurality of technology names to corresponding respective ones of said plurality of unpatented invention titles; and
step b) further includes presenting on said at least one screen at least one of said plurality of technology names corresponding to said at least one of said plurality of unpatented invention titles.

5. A method according to claim 1, wherein the data is maintained by a user entity and wherein:
step a) further comprises maintaining in said at least one database a first plurality of patents owned by said user entity in a manner that relates each of said first plurality of patents to a corresponding respective one of said plurality of market area names; and
step b) further includes presenting on said at least one screen at least one of said first plurality of patents corresponding to said at least one of siad plurality of market area names.

6. A method according to claim 5, wherein:
step a) further comprises maintaining in said at least one database a second plurality of patents not owned by said user entity in a manner that relates each of said second plurality of patents to a corresponding respective one of said plurality of market area names; and
step b) further includes presenting on said at least one screen at least one of said second plurality of patents corresponding to said at least one of siad plurality of market area names.

7. A method of processing and presenting data corresponding to unpatented inventions, comprising the steps of:
a) maintaining at least one database containing a plurality of unpatented invention titles corresponding respectively to a plurality of inventions and further containing a plurality of product names in a manner that relates ones of said plurality of unpatented invention titles to corresponding respective ones of said plurality of product names; and
b) presenting to a user at least one screen that displays at least one of said plurality of unpatented invention titles and at least one of said plurality of product names corresponding to said at least one of said plurality of unpatented invention titles.

8. A method according to claim 7, wherein:
step a) further includes maintaining in said at least one database a plurality of problem-solved statements, each directed to a problem solved by a corresponding respective one of said plurality of inventions, in a manner that relates ones of said plurality of problem-solved statements to corresponding respective ones of said plurality of unpatented invention titles; and
step b) further includes presenting on said at least one screen at least one of said plurality of problem-solved statements corresponding to said at least one of said plurality of unpatented invention titles.

9. A method according to claim 7, wherein:
step a) further includes maintaining in said at least one database a plurality of invention elements, each being an element of a corresponding respective one of said plurality of inventions, in a manner that relates ones of said plurality of invention elements to corresponding respective ones of said plurality of unpatented invention titles; and
step b) further includes presenting on said at least one screen at least one of said plurality of invention elements corresponding to said at least one of said plurality of unpatented invention titles.

10. A method according to claim 7, wherein:
step a) further includes maintaining in said at least one database a plurality of technology names, each being a technology into which at least one of said plurality of inventions is categorized, in a manner that relates ones of said plurality of technology names to corresponding respective ones of said plurality of unpatented invention titles; and
step b) further includes presenting on said at least one screen at least one of said plurality of technology names corresponding to said at least one of said plurality of unpatented invention titles.

11. A method according to claim 7, wherein the data is maintained by a user entity and wherein:
step a) further comprises maintaining in said at least one database a first plurality of patents owned by said user entity in a manner that relates each of said first plurality of patents to a corresponding respective one of said plurality of product names; and
step b) further includes presenting on said at least one screen at least one of said first plurality of patents corresponding to said at least one of siad plurality of product names.

12. A method according to claim 11, wherein:
step a) further comprises maintaining in said at least one database a second plurality of patents not owned by said user entity in a manner that relates each of said second plurality of patents to a corresponding respective one of said plurality of product names; and
step b) further includes presenting on said at least one screen at least one of said second plurality of patents corresponding to said at least one of siad plurality of product names.

13. A method of tracking data regarding a plurality of inventions each having an invention stage that is one of at least two stage types, the data having a plurality of data types, the method comprising the steps of:
a) displaying to a user via a computer a plurality of input fields corresponding to the at least two invention stages, each of said plurality of input fields having a label that identifies a corresponding respective one of the plurality of data types that relates to a respective one of the at least two stage types;
b) allowing the user to request an invention report that contains a portion of said plurality of data types, said portion varying as a function of which one of the at least two stage types the user selects; and
c) automatically generating said invention report with said portion of said plurality of data types.

14. The method according to claim 13, wherein each of the at least two stage types are selected from the group consisting of awaiting interview, awaiting first draft, awaiting invention review, awaiting disclosure submit, awaiting review board and awaiting patent docket.
